(19) United States
(12) Patent Application Publication
(10) Pub. No.: US 2016/0110209 A1
(43) Pub. Date: Apr. 21, 2016

(54) APPARATUS AND METHOD FOR PERFORMING MULTI-CORE EMULATION BASED ON MULTI-THREADING

(71) Applicant: ELECTRONICS AND TELECOMMUNICATIONS RESEARCH INSTITUTE, Daejeon (KR)

(72) Inventor: Jae-Jin LEE, Daejeon (KR)

(73) Assignee: ELECTRONICS AND TELECOMMUNICATIONS RESEARCH INSTITUTE, Daejeon (KR)

(21) Appl. No.: 14/793,259

(22) Filed: Jul. 7, 2015

(30) Foreign Application Priority Data
Oct. 20, 2014 (KR) 10-2014-0142016

(51) Int. Cl. G06F 9/455; G06F 9/50

(52) U.S. Cl. CPC G06F 9/455; G06F 9/5011

(57) ABSTRACT

The present invention relates to multi-core emulation, more specifically to a method and an apparatus for high-speed multi-core emulation using a multi-threading functionality of a computer.

An apparatus for multi-core emulation based on multi-threading in accordance with the present invention includes: an emulation manager configured to emulate a plurality of cores simultaneously by generating emulation function for the plurality of cores, respectively, as respective threads; and a resource scheduler configured to adjust an order of use of shared resources so as not to have a race condition occurred between two or more cores of the plurality of cores accessing the shared resources simultaneously.

### CROSS-REFERENCE TO RELATED APPLICATIONS

This application claims the benefit of Korean Patent Application No. 10-2014-0142016, filed with the Korean Intellectual Property Office on Oct. 20, 2014, the disclosure of which is incorporated herein by reference in its entirety.

### BACKGROUND

1. Technical Field

The present invention relates to multi-core emulation, more specifically to a method and an apparatus for high-speed multi-core emulation using a multi-threading functionality of a computer.

2. Background Art

The processors that are currently used in smart devices are in the process of being evolved from a single core to a quad-core and are expected to be developed to a multi-core form of octa-core or more, considering the advancement of processors, which are also being increasingly smaller. Moreover, the next-generation mobile terminals will use a multi-core processor having tens to hundreds of processors integrated therein to enable biometrics and augmented realities.

Required for development of an optimal SoC structure based on a multi-core processor is a system level design methodology based on a virtual prototype for an early analysis of SoC functions and performances at a higher level. The most important factor to be considered when designing the virtual prototype-based system is designing a high-speed emulator in which functions of the multi core are modeled in a function-accurate level.

It is important to consider scalability and speed when developing a multi-core emulator that will be evolved to a many-core emulator.

The conventionally-used multi-core emulators are configured to emulate the cores successively by simply having a single core emulated by an emulation manager, without adopting any parallelization, and thus become significantly slower if the number of cores is increased.

### SUMMARY

Certain embodiments of the present invention provide an apparatus and a method for performing multi-core emulation using a multi-threading functionality of a host computer that is faster than conventional emulators and is scalable to flexibly address an increased number of cores.

An apparatus for multi-core emulation based on multi-threading in accordance with an embodiment of the present invention may include: an emulation manager configured to emulate a plurality of cores simultaneously by generating emulation function for the plurality of cores, respectively, as respective threads; and a resource scheduler configured to adjust an order of use of shared resources so as not to have a race condition occurred between two or more cores of the plurality of cores accessing the shared resources simultaneously.

A method for performing multi-core emulation based on multi-threading in accordance with an embodiment of the present invention may include: emulating a plurality of cores simultaneously by generating emulation function for the plurality of cores, respectively, as respective threads; and adjusting an order of use of shared resources so as not to have a race condition occurred between two or more cores of the plurality of cores accessing the shared resources simultaneously.

According to certain illustrative embodiments of the present invention, it is possible to realize a high-speed multi-core emulation through thread-level parallelization, by dynamically assigning cores to their respective threads and simultaneously emulating the cores in the plurality of threads while running multiple cores based on multi-threading.

Moreover, even if the number of cores is increased, as in the case of the many-core, the apparatus and the method in accordance with the present invention are highly scalable because many-core emulation can be realized by increasing the number of threads.

The present invention may be used in various applications for developing an optimal SoC and software based on a multi-core processor.

### BRIEF DESCRIPTION OF DRAWINGS

FIG. 1 illustrates various types of processor core emulation techniques.

FIG. 2 is a detailed illustration of a high speed emulation techniques using dynamic code translation.

FIG. 3 is a conceptual diagram showing the conventional multi-core emulation.

FIG. 4 is a block diagram showing an apparatus for performing multi-core emulation in accordance with an embodiment of the present invention.

FIG. 5 shows a detailed configuration of a resource scheduler in accordance with an embodiment of the present invention.

FIG. 6 is a flow diagram showing a method for performing multi-core emulation in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain technology is determined to evade the point of the present invention, the pertinent detailed description will be omitted.

Unless otherwise stated, any expression in singular form in the description and the claims shall be interpreted to generally mean “one or more.”

Firstly, various techniques of processor core emulation will be described to help understanding of the present invention.

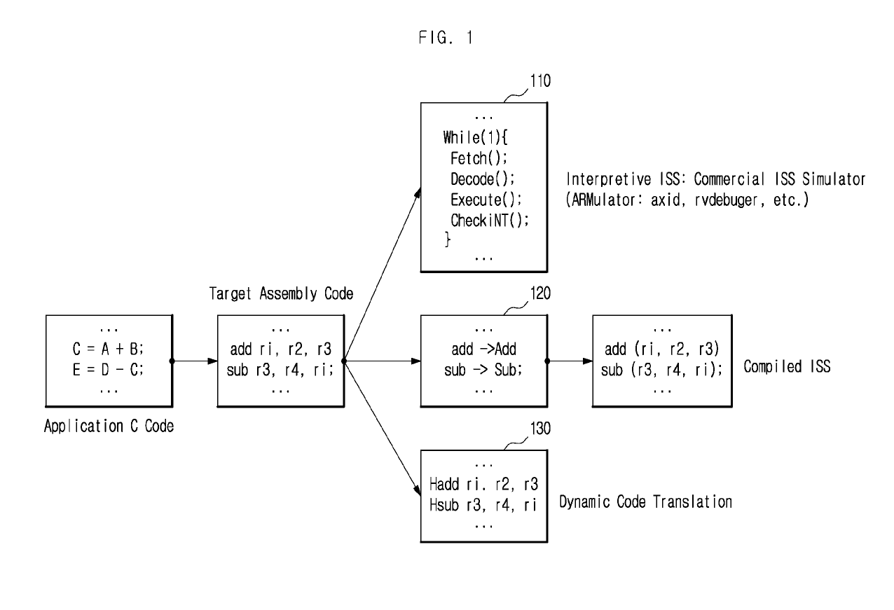

FIG. 1 illustrates various types of processor core emulation techniques.

As illustrated, the processor core emulation techniques include an interpretive ISS (Instruction Set Simulation) technique 110, a compiled ISS technique 120 and a DCT (Dynamic Code Translation) technique 130.

In the interpretive ISS technique 110, a pipeline of a processor core is modeled and emulated. An example of a commercial ISS simulator is ARMulator.

The compiled ISS techniques 120 has a 10 to 100 times faster emulation speed than the interpretive ISS technique 110.

The DCT technique 130, which emulates a target code by translating the target code to a machine code, can emulate the processor core about 1,000 times faster than the interpretive ISS technique 110.

Developing a driver, firmware and application on a virtual platform emulator requires high-speed processor core emulation of 10 to 100 MIPS, and widely used presently is the processor core emulation technique based on dynamic code translation.

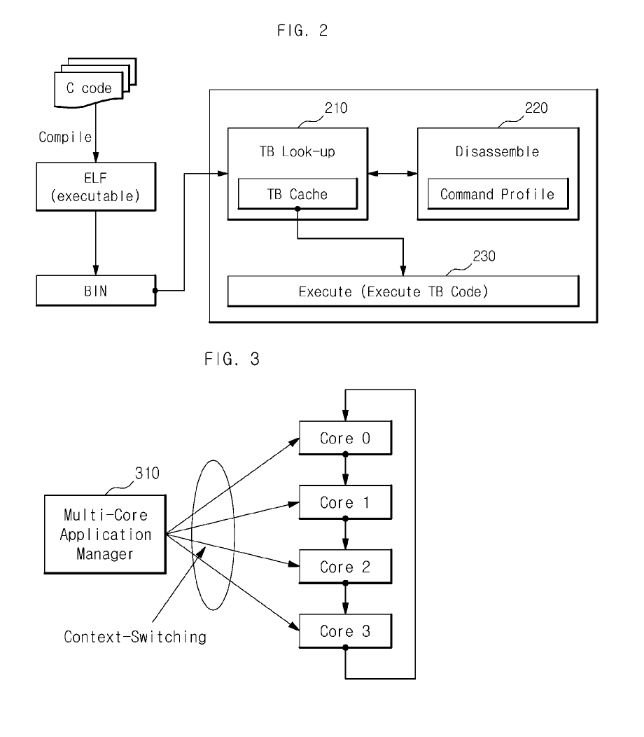

FIG. 2 is a detailed illustration of a high speed emulation techniques using dynamic code translation. As illustrated in FIG. 2, a translation block (TB) is searched for (210) by reading a command from a binary image. If the searched TB is not found in a TB cache, a disassembling process is carried out (220). In the disassembling process, the role of a command is assessed using a command profile, and the command is converted to a set of host machine (x86) commands. The TB is stored in the TB cache and may be later used as a function of the host machine. Since the TB stored in the TB cache may be searched for and used if the same command needs to be executed later, the disassembling process (220), which requires a large amount of time, may be skipped, thereby possibly improving the emulation speed by about 10 times.

FIG. 3 is a conceptual diagram showing the conventional multi-core emulation. As illustrated, in the conventional multi-core emulation method, a multi-core emulation manager 310 performs emulation by context-switching multiple cores (e.g., Core 0 through Core 3) in a sequential manner (e.g., the round robin method), without utilizing any parallelization. Since a function corresponding to each core is simply duplicated in a program that emulates a single core, and the function of each core is sequentially executed by the emulation manager, the emulation speed is significantly reduced with a greater number of cores.

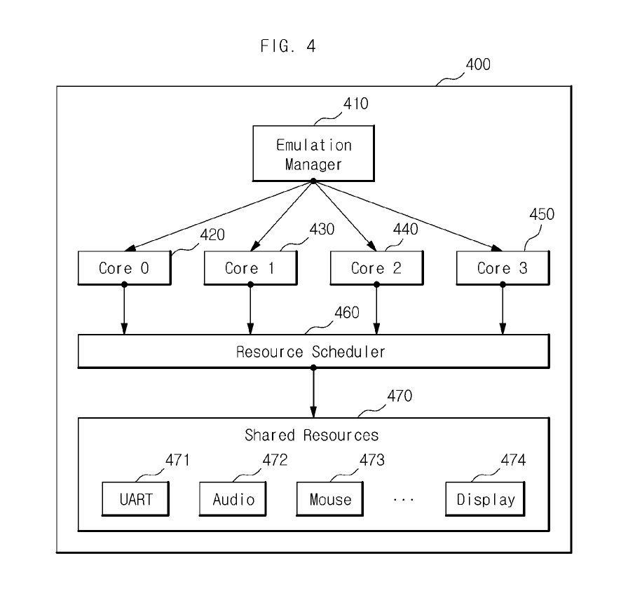

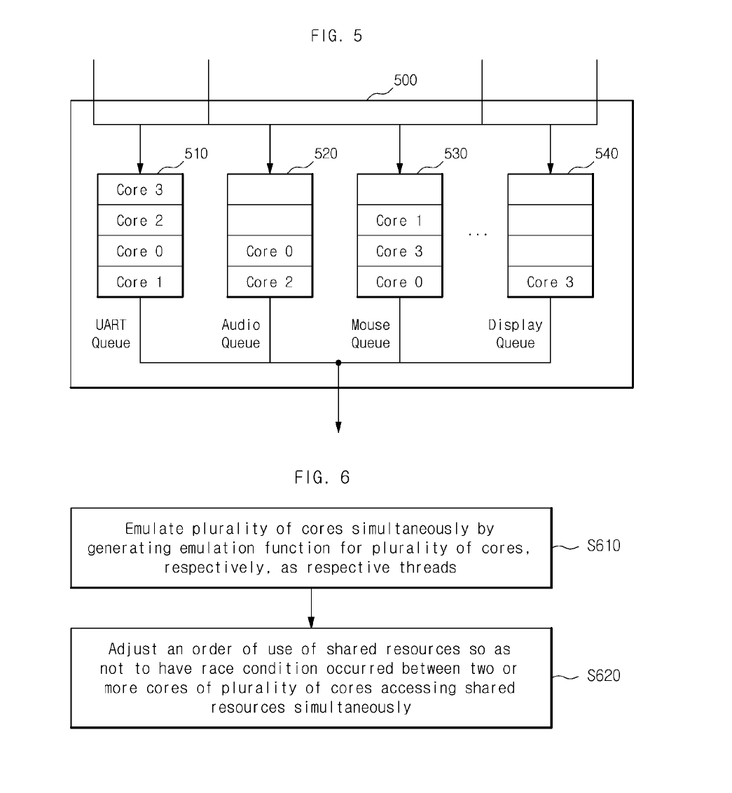

To solve this problem, the present invention suggests an apparatus and a method for performing multi-core emulation using a multi-threading functionality of a host computer that is faster than conventional emulators and is scalable to flexibly address an increased number of cores. Hereinafter, certain illustrative embodiments of the present invention will be described in detail with reference to FIG. 4 and FIG. 5.

FIG. 4 is a block diagram showing an apparatus for performing multi-core emulation in accordance with an embodiment of the present invention.

As illustrated, a multi-core emulation apparatus 400 may include an emulation manager 410, a plurality of cores 420-450, a resource scheduler 460 and shared resources 470.

In an embodiment, the emulation manager 410 may emulate the plurality of cores simultaneously by generating emulation functions for the plurality of cores, respectively, as their respective threads 420-450. The emulation manager 410 recognizes a core as a single task, and generates the emulation function of each core as a thread and emulates multiple threads simultaneously, thereby performing multi-core emulation through a thread-level parallelization. Data that is independent of the cores may be, for example, a register file, and the multi-core emulation is performed in basic units of functional units that perform a task for the independent data.

By dividing a program into a plurality of threads, there is no restriction of access between the treads for the independent data, but the access to the shared resources 470, such as UART 471, audio 472, mouse 473 and display 474, may need to be controlled lest a race condition should be occurred.

The resource scheduler 460, which are for addressing this requirement, may adjust an order of use of the shared resources 470 so as not to have the race condition occurred between the cores in case two or more cores access the shared resources 470 at the same time.

In an embodiment, the resource scheduler 460 determines an order of priority of the cores and allows a core having a higher priority to use a resource first, in case the cores access the shared resources simultaneously.

In an embodiment, a core having a lower identifier value may be allowed to have a higher priority and may be allowed to use the resource first.

FIG. 5 shows a detailed configuration of a resource scheduler in accordance with an embodiment of the present invention. As illustrated in FIG. 5, a resource scheduler 500 includes queues 510-540 associated, respectively, with shared resources. In case a core accesses the shared resources but a particular resource is already in use by another core, the resource scheduler 500 stores a resource request of the core in a queue 510-540 associated with the particular resource and allows the request stored in the queue to be processed sequentially after the current core using the resource completes its task. Although 4 queues are illustrated in FIG. 5 for the convenience of description and understanding, it shall be appreciated that the number and size of the queues may vary depending on the number of cores, the number of shared resources and other factors.

FIG. 6 is a flow diagram showing a method for performing multi-core emulation in accordance with an embodiment of the present invention.

In S610, a plurality of cores are emulated simultaneously by generating emulation functions for the plurality of cores, respectively, as their respective threads.

In S620, in case at least two cores among the plurality of cores access shared resources at the same time, an order of use of the shared resources are adjusted so as not to have a race condition occurred between the cores.

In an embodiment, among the cores accessing the shared resources simultaneously, the core having a lower identifier value may be controlled to use the shared resources first.

The multi-core emulation technique suggested by the present invention is function-accurate emulation and thus does not cause an inter-core synchronization problem that may be occurred in an instruction-accurate multi-core emulation, and may use a shared memory to realize data communication and synchronization, if necessary, between the cores.

The apparatus and the method in accordance with an embodiment of the present invention may be implemented in the form of program instructions that are executable through various computer means and written in a computer-readable medium, which may include program instructions, data files, data structures, or the like, in a stand-alone form or in a combination thereof.

The program instructions stored in the computer readable medium can be designed and configured specifically for the present invention or can be publically known and available to those who are skilled in the field of software. Examples of the computer readable medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. An apparatus for multi-core emulation based on multi-threading, comprising:
an emulation manager configured to emulate a plurality of cores simultaneously by generating emulation function for the plurality of cores, respectively, as respective threads; and
a resource scheduler configured to adjust an order of use of shared resources so as not to have a race condition occurred between two or more cores of the plurality of cores accessing the shared resources simultaneously.

2. The apparatus of claim 1, wherein the resource scheduler is configured to determine an order of priority of the cores and allows a core having a higher priority among the cores accessing the shared resources simultaneously to use the shared resource first.

3. The apparatus of claim 1, wherein the resource scheduler is configured to control a core having a lower identifier value among the cores accessing the shared resources simultaneously to use the shared resources first.

4. The apparatus of claim 1, wherein the resource scheduler comprises queues for the shared resources.

5. The apparatus of claim 4, wherein the resource scheduler stores a shared resource request from one core in the queue associated with the shared resource, when the shard resource is already being used by another core.

6. A method for performing multi-core emulation based on multi-threading, comprising:
emulating a plurality of cores simultaneously by generating emulation function for the plurality of cores, respectively, as respective threads; and
adjusting an order of use of shared resources so as not to have a race condition occurred between two or more cores of the plurality of cores accessing the shared resources simultaneously.

7. The method of claim 6, wherein the adjusting of an order of use of shared resources comprises controlling a core having a lower identifier value among the cores accessing the shared resources simultaneously to use the shared resources first.

8. The method of claim 6, wherein the adjusting of an order of use of shared resources comprises controlling a core having a higher priority among the cores accessing the shared resources simultaneously to use the shared resources first.

9. The method of claim 6, wherein the adjusting of an order of use of shared resources comprises storing a shared resource request from one core in the queue associated with the shared resource, when the shard resource is already being used by another core.
